(19) United States
(12) Patent Application Publication
(10) Pub. No.: US 2015/0143439 A1
(43) Pub. Date: May 21, 2015

(54) PROVIDING INCREASED BANDWIDTH FOR TRANSMISSION OF AUDIO VIDEO CONTENT AND SUPPLEMENTAL CONTENT ASSOCIATED THEREWITH

(71) Applicant: SONY CORPORATION, Tokyo (JP)

(72) Inventor: Luke V. Fay, San Diego, CA (US)

(73) Assignee: SONY CORPORATION, Tokyo (JP)

(21) Appl. No.: 14/084,241

(22) Filed: Nov. 19, 2013

(51) Int. Cl. H04N 21/2385; H04N 21/81; H04N 21/4722; H04N 7/12; H04N 21/262

(52) U.S. Cl. CPC H04N 21/2385; H04N 7/12; H04N 21/26216; H04N 21/4722; H04N 21/8126
USPC 725/95

(57) ABSTRACT

A device includes at least one computer readable storage medium bearing instructions, and at least one processor configured for accessing the computer readable storage medium to execute the instructions. The instructions configure the processor for providing audio video (AV) content on a first channel having a predefined frequency range, receiving a request for data associated with the AV content, and determining whether the first channel has sufficient bandwidth to concurrently provide at least portions of both the AV content and the data responsive to receiving the request. The instructions further configure the processor for expanding the first channel beyond the predefined frequency range to include at least one frequency above or below the predefined frequency range to render an expanded first channel responsive to a determination that the first channel does not have sufficient bandwidth, and concurrently providing the requested data and AV content over the expanded first channel.

### FIELD OF THE INVENTION

The present application relates generally to providing content on television channels and/or AV content channels.

### BACKGROUND OF THE INVENTION

There may arise certain instances where a content provider such as a network broadcaster may wish to provide content such as audio video (AV) content, and also provide supplemental content (e.g. such as large file delivery and/or UHDTV streaming content, etc.) to the AV content. However, television channels on which such content is provided typically have a fixed bandwidth capacity, and hence the television channel is limited as to the amount of content that can be provided over it at any given time. The fixed capacity of the channel thus limits the ability of the content provider to provide AV content and supplemental content.

### SUMMARY OF THE INVENTION

Accordingly, in one aspect a first device includes at least one computer readable storage medium bearing instructions executable by a processor and at least one processor configured for accessing the computer readable storage medium to execute the instructions. The instructions configure the processor for providing audio video (AV) content on a first channel having a predefined frequency range, receiving a request for data associated with the AV content, and determining whether the first channel has sufficient bandwidth to concurrently provide at least portions of both the AV content and the data responsive to receiving the request. The instructions also configure the processor for expanding the first channel beyond the predefined frequency range to include at least one frequency above or below the predefined frequency range to render (e.g. after checking if the spectrum is free on either side of the RF channel) an expanded first channel responsive to a determination that the first channel does not have sufficient bandwidth to concurrently provide at least portions of both the AV content and the data, and concurrently providing the requested data and AV content over the expanded first channel. The AV content may in some embodiments include a real time broadcast of an occurrence such as a sporting event or live news telecast, and the requested data may be video content of a different viewing angle of the occurrence relative to a primary viewing angle.

In some embodiments, the expanding may include accessing a database of available frequencies, and determining at least one available frequency above or below the first channel into which the first channel can expand (e.g. a frequency used by white space devices) responsive to parsing at least a portion of the database. The available frequency above or below the first channel may be part of a second channel, and/or may be part of available white space between channels. If part of a second channel, the available frequency of the second channel into which the first channel is expanded may be relinquished to the first channel for a predefined period of time by an entity controlling the second channel, and the entity may even define the predefined period itself.

Also in some embodiments, the expanding may include determining whether the at least one available frequency is currently being used for transmitting data responsive to determining at least one available frequency above or below the first channel into which the first channel can expand based on at least a portion of the database. Furthermore, if desired the determining whether the at least one available frequency is currently being used for transmitting data may include sensing whether energy indicative of current content transmission is present at the frequency.

Further still, in some embodiments the requested data is first data, and responsive to expanding the first channel to include the at least one frequency above or below the first channel and prior to concurrently providing the requested data and AV content over the expanded first channel, the processor when accessing the instructions may be further configured for transmitting second data not including the first data or the AV content. The second data in some embodiments may be dummy data or e.g. metadata unassociated with the AV content.

In embodiments where the request is received from a multichannel video programming distributor (MVPD), the first device may be associated with a network broadcaster, and the first device may transmit a notification to the MVPD indicating the at least one frequency above or below the predefined frequency range which the MVPD is to tune to receive the requested data.

In embodiments where at least a portion of the AV content is provided to a second device such as a CE device through an MVPD, the first device may transmit a notification through the MVPD indicating the at least one frequency above or below the predefined frequency range for which the second device is to tune using a terrestrial broadcast receiver at the second device to receive the requested data at the second device.

In another aspect, a computer readable storage medium that is not a carrier wave bears instructions which when executed by a processor of a first consumer electronics (CE) device configure the processor to execute logic comprising receiving content on a first channel having a predefined frequency range, receiving from a provider of the content an indication of a second channel on which supplemental data associated with the content will be provided or is being provided, and configuring the CE device to receive the supplemental data over the second channel.

In still another aspect, a method includes bonding at least a portion of a first television channel with a second television channel, and providing content on the bonded channel (e.g. providing jointly or separately (one whole piece of a service or separate services)).

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example consumer electronics (CE) device in accordance with present principles;

FIGS. 2 and 4 are exemplary flowcharts of logic to be executed by a content provider in accordance with present principles;

FIGS. 3 and 5 are exemplary flowchart of logic to be executed by a CE device in accordance with present principles;

FIGS. 6 and 7 show exemplary user interfaces (UIs) presentable on a CE device in accordance with present principles; and

FIG. 8 shows an exemplary indication presentable on a CE device of supplemental content to AV content that is available.

### DETAILED DESCRIPTION OF THE PREFERRED EMBODIMENT

This disclosure relates generally to consumer electronics (CE) device based user information. With respect to any computer systems discussed herein, a system herein may include server and/or head end, and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data-lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software modules described by way of flow charts and/or user interfaces herein can include various sub-routines, procedures, etc. It is to be understood that logic divulged as being executed by a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

In an example, a processor can access information over its input lines from data storage, such as the computer readable storage medium, and/or the processor accesses information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the CE device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

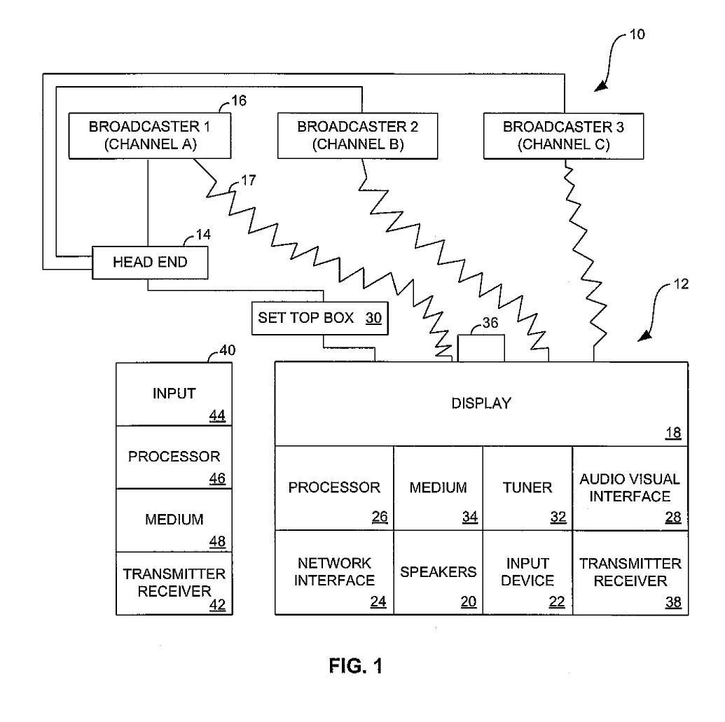

Now specifically referring to FIG. 1, an example system 10 is shown, which may include at least one consumer electronics (CE) device 12 such as e.g. a high definition Internet-enabled computerized (e.g. “smart”) television (TV), at least one head end 14, and at least one broadcaster 16. Beginning first by describing the CE device 12, it includes one or more touch-enabled displays 18, one or more speakers 20 for outputting audio in accordance with present principles, and at least one additional input device 22 such as e.g. an audio receiver/microphone for e.g. entering audible commands to the CE device 12 to control the CE device 12.

The example CE device 12 may also include one or more network interfaces 24 for communication over a network such as e.g. the Internet, a WAN, a LAN, etc. under control of one or more processors 26 with e.g. a server and/or other CE devices (not shown). It is to be understood that the processor 26 controls the CE device 12 to undertake present principles, including controlling the other elements of the CE device 12 described herein such as e.g. controlling the display 18 to present images/content thereon. Furthermore, note the network interface 24 may be, e.g., a wired or wireless modem or router, or other appropriate interface such as, e.g., a wireless telephony transceiver, Wi-Fi transceiver, etc.

In addition to the foregoing, the CE device 12 may also include e.g. an audio video (AV) interface 28 such as, e.g., a USB or HDMI port for receiving input from a component device such as e.g. a set top box 30 or Blue Ray disc player (not shown) connected thereto for presentation of the content on the CE device 12. The CE device 12 also includes as a tuner 32 configured for receiving e.g. terrestrial-broadcasted content in accordance with present principles such as e.g. receiving content from one or more broadcasters 16. The broadcasters 16 may be e.g. network broadcasters broadcasting content using e.g. a respective terrestrial broadcast signal 17. In addition to the foregoing, the CE device 12 may further include one or more tangible computer readable storage mediums 34 such as disk-based or solid state storage, it being understood that the computer readable storage medium 34 may not be a carrier wave.

Also in some embodiments, the CE device 12 can include a position or location receiver such as but not limited to a GPS receiver (not shown) that is configured to e.g. receive geographic position information from at least one satellite and provide the information to the processor 26. However, it is to be understood that another suitable position receiver other than a GPS receiver may be used in accordance with present principles to e.g. determine the location of the CE device 12.

Continuing the description of the CE device 12, in some embodiments the CE device 12 may include one or more cameras 36 that may be, e.g., a thermal imaging camera, a digital camera such as a webcam, and/or a camera integrated into the CE device 12 and controllable by the processor 26 to gather pictures/images and/or video. Also included on the CE device 12 may be a transmitter/receiver 38 for communicating with a remote commander (RC) 40 associated with the CE device 12 and configured to provide input (e.g., commands) to the CE device 12 (e.g. to the processor 26) to thus control the CE device 12. Accordingly, the RC 40 also has a transmitter/receiver 42 for communicating with the CE device 12 through the transmitter/receiver 42. The RC 40 also includes an input device 44 such as a keypad or touch screen display, as well as a processor 46 for controlling the RC 40 and a tangible computer readable storage medium 48 such as disk-based or solid state storage. Though not shown, in some embodiments the RC 40 may also include a touch-enabled display screen and a microphone that may be used for providing input/commands to the CE device 12 in accordance with present principles.

Now in reference to the afore-mentioned head end 14, it is to be understood that in example embodiments the head end 14 may be e.g. a cable head end and/or a satellite head end. The head end 14 is understood to be configured for communication with the CE device 12 (e.g., through the set top box 30) over, e.g., a closed network (through a wired or wireless connection), and furthermore may itself include a network interface (not shown) such that the head end 14 may communicate with the CE device 12 over a wide-area and/or open network such as the Internet. Further still, it is to also be understood that the head end 14 may be wired or wirelessly connected to a non-internet server and/or Internet server, and/or may optionally be integrated with a non-internet server and/or Internet server. In addition to the foregoing, the head end 14 is understood to be e.g. wired or wirelessly connected to the one or more broadcasters 16 to receive content therefrom and provide it to the CE device 12.

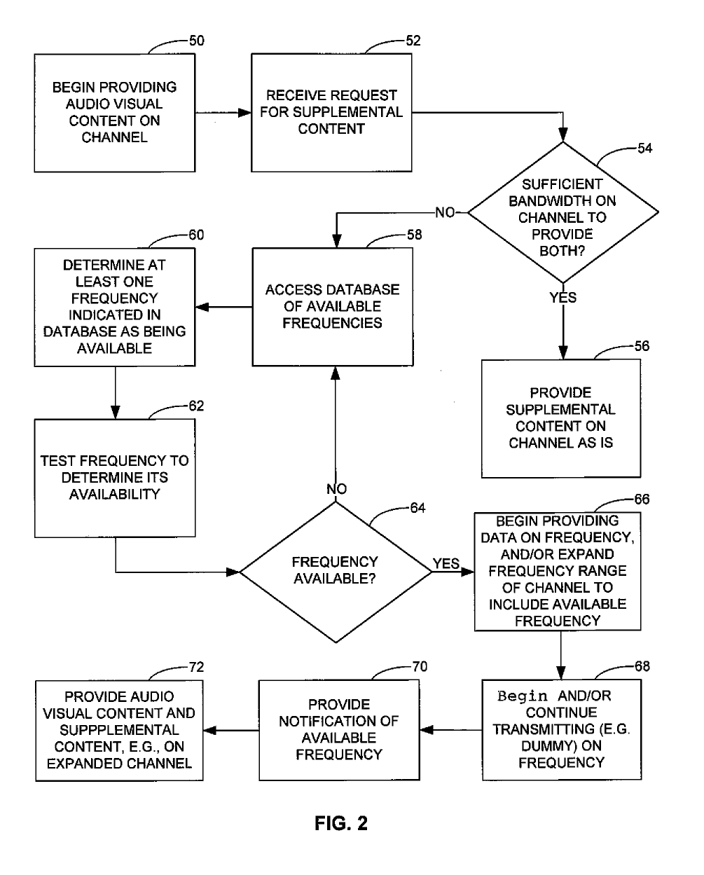

Before moving on to FIG. 2, it is to be understood that the CE device 12 though described in exemplary embodiments as being a TV, may be any other device suitable for undertaking present principles such as e.g. a computerized Internet enabled (“smart”) telephone (e.g. with mobile (e.g. digital) TV capability), a tablet computer, a notebook computer, a wearable computerized device such as e.g. computerized Internet-enabled watch, a computerized Internet-enabled music player, etc. Regardless, it is to be understood that the CE device 12 is configured to undertake present principles (e.g. to execute the logic described herein, present the user interfaces (UIs) described herein, and perform any other functions and/or operations described herein). Likewise, it is to be understood that the head end 14 and one or more broadcasters 16 are configured to store (e.g. on respective computer readable storage mediums) and undertake respective logic as described below (e.g. using respective processors).

Turning now to FIG. 2, an example flowchart of logic is shown that may be executed by e.g. a head end such as a multichannel video programming distributor (MVPD) and/or the head end 14 described above, and/or that may be executed by a (e.g. network) broadcaster such as the broadcaster 16 described above. Beginning at block 50, the logic begins providing audio video (AV) content on at least one (e.g. television) channel, it being understood that the channel may have a predefined frequency range (e.g., defined by the head end 14 or broadcaster 16, and/or defined by a government agency). In any case, after block 50 the logic proceeds to block 52 where the logic may receive a request for data and/or supplemental content associated with the AV content being provided, such as e.g. an interactive feature (e.g. transmitting votes from the CE device 12 to the head end and/or broadcaster for a contest associated with the AV content, playing a game associated with the AV content, etc.), metadata, and/or additional audio and/or video content such as a different viewing angle or audio feed of the same occurrence such as a sporting event or live news broadcast. After block 52, the logic proceeds to decision diamond 54, to be described shortly. But first, it is to be understood that in addition to or in lieu of receiving such a request, the logic may determine whether supplemental content is in fact available and responsive to determining that such content is available may proceed to decision diamond 54.

Regardless, at decision diamond 54, the logic determines whether the channel on which the AV content is provided includes sufficient bandwidth for which to (e.g. concurrently) provide (e.g. at least portions of) both the AV content and supplemental content. If the logic determines at diamond 54 that the e.g. current channel on which the AV content is being provided has sufficient bandwidth to concurrently provide the corresponding supplemental content, the logic may proceed to block 56 where at least portions of both the AV content and the supplemental content are concurrently provided over the channel. However, if at diamond 54 the logic determines that the current channel does not have sufficient bandwidth to concurrently provide at least portions of the AV content and the supplemental content, the logic instead moves from diamond 54 to block 58.

At block 58, the logic accesses a database that at least includes (e.g. a listing, table, or indication of) frequencies that are (e.g. currently) available for transmitting data, and then at block 60 the logic determines and/or identifies based on accessing (and e.g. parsing and/or analyzing) the database at least one frequency indicated in the database as being available for transmitting content. It is to be understood that in some embodiments, the logic may not only determine and/or identify such a frequency, but may determine and/or identify an available frequency that is proximate to and/or near at least one frequency of the channel otherwise providing the AV content, it being further understood that in some embodiments the channel includes (e.g. and/or is defined by) a predefined frequency range (e.g. a range of 6 GHz) having e.g. a fixed bandwidth. Thus, for instance, at block 60 the logic may identify a frequency indicated in the database as being available that is (e.g. immediately) above or below the frequency range of the channel providing the AV content.

Before moving on, it is to be understood that a database and/or data table such as that referenced above may be a database for (e.g. access by) mobile digital television systems (e.g. mobile DTV) maintained on behalf of the Advanced Television Systems Committee (ATSC) by one or more organizations for supporting e.g. white space devices by indicating one or more frequencies on which white space devices may communicate.

In any case, after block 60 the logic proceeds to block 62 where the logic e.g. tests and/or senses whether a frequency indicated in the database as being available is nonetheless currently being used to transmit data (e.g. despite being indicated in the database as being available). The logic may do so by e.g. sensing whether energy is currently present and/or bandwidth occupied on the subject frequency that is thus indicative of data already being transmitted using the frequency (e.g. from a different data provider). Thus, at decision diamond 64 the logic determines whether the frequency indicated in the database as being available is currently available for transmitting data (e.g. that it is not already being used for transmitting data despite the database indicating it is available). If the logic determines that the frequency is currently unavailable (e.g. that it is already being used to transmit data), the logic may revert back to block 58 to determine another frequency indicated in the database as being available and proceed therefrom. However, if the logic determines that the frequency is currently available, the logic instead proceeds to block 66 where the logic may begin transmitting data on the available frequency (e.g. if the frequency will not form part of an expanded channel).

Also, at block 66 and in embodiments where the available frequency is e.g. proximate or adjacent to the (e.g. predefined) frequency range of the channel providing the AV content (e.g. sometimes referred to herein as the “subject” channel), the logic may expand the frequency range of the channel providing the AV content to include the available frequency, thereby increasing the available bandwidth of the channel. Furthermore, in such embodiments note that the available frequency above or below the subject channel may form part of a another channel, in which case the other channel that is not necessarily associated with the same content provider as the subject channel may temporarily or permanently relinquish to the subject channel the available frequency. Furthermore, if relinquished temporarily, the entity associated with the other channel (e.g. another content provider, network broadcaster, etc.) may do so for a predefined period of time established by the entity associated with the other channel, where the predefined period of time may be communicated (e.g. using an electronic notification) to the content provider of the subject channel, thus notifying the content provider of the subject channel of how long the subject channel is permitted to expand into the available frequency to provide data thereon.

Moreover and regardless of whether the available frequency is proximate or adjacent to the subject channel, note that the entity associated with the other channel relinquishing control of at least one of its frequencies may also be notified by the content provider of the subject channel that the content provider of the subject channel will be using the available frequency, thereby providing the entity associated with the other channel the opportunity to establish a predefined period of time and notify the content provider of the subject channel of as much.

Notwithstanding, it is to be further understood that in addition to or in lieu of providing data on an available frequency that typically forms part of another channel, in some embodiments the available frequency may be part of white space between channels and/or used by white space devices.

Still in reference to FIG. 2, after block 66 the logic proceeds to block 68 where the logic may transmit data (e.g. dummy data and/or metadata) other than the supplemental content and/or AV content (e.g. if supplemental content is to be provided on the available frequency in accordance with present principles but the appropriate or desired time to do so has not yet arrived). It is to be understood that transmitting dummy data and/or metadata may effectively reserve the available frequency for the content provider to provide the supplemental content by causing the available frequency to be “occupied” by some data albeit not the AV content or supplemental content, thereby preventing other devices from transmitting data at that frequency as well. This also provides a means to e.g. expand and contract bandwidth based on user needs.

After block 68, the logic proceeds to block 70 where the logic may transmit a notification to the CE device to receive the supplemental content and/or AV content (e.g. the device that provided the request at block 52) indicating the available frequency on which the supplemental content will be provided so that the receiving device may thus tune to or otherwise be configured to receive data over the frequency indicated in the notification, e.g. if need be. The logic may then conclude at block 72 where the logic concurrently provides the supplemental content and AV content, with the supplemental content being provided on the frequency determined to be available (e.g. whether that be a frequency adjacent to the channel or not). Thus, in some embodiments at block 72 the logic may provide the supplemental content and AV content on the subject channel if expanded to include the frequency determined to be available as set forth above, and otherwise may provide the supplemental content on the frequency determined to be available while (e.g. separately) providing the AV content on the channel still having a predefined frequency range that has not necessarily been expanded.

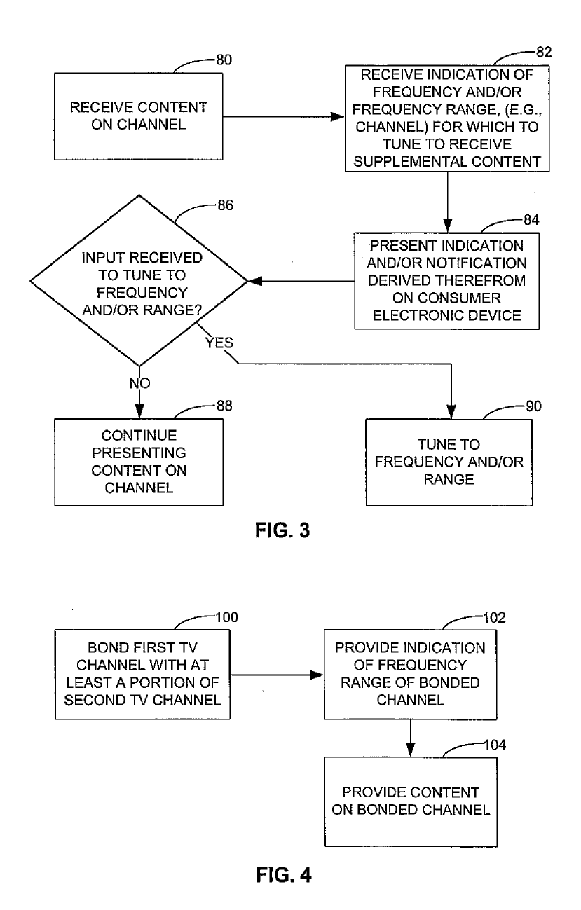

Before moving on to FIG. 3, it is to be understood that the logic of FIG. 2 may be executed in some embodiments by an MVPD as described above, but in addition to or in lieu of being executed by an MVPD, the logic may also be executed by a broadcaster. Thus, for instance, in one embodiment the request received at block 52 may be from an MVPD and received by a broadcaster. In such an embodiment, the broadcaster may transmit a notification at block 70 to the MVPD indicating the available frequency for which the MVPD is to tune to receive the requested data. In turn, the MVPD may then provide the AV content and supplemental content to a CE device and hence an end-user. Further, note that since some channels provided by MVPDs to CE devices also have a predefined frequency range, they too may be expanded (e.g. and/or bonded) in accordance with present principles, and/or an available frequency not necessarily adjacent to a predefined MVPD-to-CE device channel (e.g. established by the MVPD) may be used to provide supplemental content (e.g. with the CE device receiving a notification of the available frequency for which to tune).

Notwithstanding, it is to be further understood that in some embodiments, e.g. an MVPD may not wish to provide supplemental content to AV content to a CE device and/or otherwise enable supplemental content from a broadcaster to be passed through the MVPD's network to a CE device. Thus, present principles recognize that a (e.g. terrestrial broadcast) frequency determined to be available by a broadcaster for providing supplemental content may be indicated in, form part of, and/or be embedded in video of the AV content for which the supplemental content is associated. For example, a visual indication that the AV content has supplemental content associated therewith that can be accessed on a different frequency and/or channel broadcasted terrestrially may be embedded in video of the AV content rather than provided as metadata. Thus, such information (e.g. indicated a notification) may nonetheless be provided to a CE device (e.g. via terrestrial broadcast, and further e.g. wherein the receiver may employ two tuners, one for the MVPD channel lineup and one for the terrestrial lineup) even when an MVPD would otherwise refuse to use the metadata to provide the notification or otherwise provide the metadata to the CE device (e.g. for the CE device to use the metadata to present a notification in accordance with present principles) when providing (e.g. a terrestrial-broadcasted) AV content over its own network. In any case, it is to be understood that the CE device presenting the AV content from the MVPD with a notification included as part of the video of the AV content (e.g. received over a second of two device tuners for such purposes) may be manipulated by a user to tune to a terrestrial broadcast using a terrestrial broadcast receiver (e.g. rather than an MVPD-provided set top box) to thereby access the supplemental content at the CE device.

Continuing the detailed description now in reference to FIG. 3, exemplary logic to be executed by a CE device such as the CE device 12 is shown. Beginning at block 80, the logic receives content on a first channel, where the first channel may have a predefined frequency range. The logic then proceeds to block 82 where the logic receives an indication in accordance with present principles of a frequency, frequency range, and/or channel for which to tune to receive supplemental content being provided thereon or that will be provided thereon. Thus, at block 84 the indication is presented on the CE device (e.g. if embedded in video as set forth above, if an MVPD elects to provide it, if received over a terrestrial broadcast, etc.). Nonetheless, note that in some embodiments at block 84, the logic may in addition to or in lieu of providing the indication may present a notification derived from the indication.

In any case, after block 84 the logic proceeds to decision diamond 86 where the logic determines whether input (e.g. from a user of the CE device) has been received at the CE device to tune to the frequency, frequency range, and/or channel indicated in the indication received at block 82. If the logic determines no such input has been received, the logic proceeds to block 88 where the logic continues presenting content on the first channel. However, if the logic determines that input to tune to the frequency, frequency range, and/or channel has been received, the logic instead proceeds to block 90 where the logic tunes to or otherwise configures the CE device to receive the supplemental content over the indicated frequency, frequency range, and/or different channel (e.g. using a terrestrial broadcast receiver) and to present the supplemental content.

Now in reference to FIG. 4, exemplary logic to be executed by a head end (e.g. an MVPD) and/or broadcaster is shown. The logic begins at block 100 where the logic bonds (e.g. using channel bonding) at least a portion of a first television channel with a second television channel. In some embodiments, this bonding of two channels or at least a portion thereof (e.g. one or more frequencies of the channel's frequency range) may be permanent in that e.g. the frequency bonded to the other channel and/or the entire channel if bonded is from the point of bonding controllable by the content provider providing content on the bonded channel (e.g. indefinitely) and is no longer controllable by the content provider that relinquished control. This may be desirable, e.g., where a content provider relinquishing control often does not use all available bandwidth on its respective channel when providing content, while a neighboring channel does not have enough bandwidth to provide its content (e.g. AV and supplemental content), and hence the entities controlling the two channels may have contracted with each other to allow for bonding of at least one frequency from one channel to the other channel.

Regardless, after block 100 the logic proceeds to block 102 where a notification of the (e.g. new) frequency range of the bonded channel (e.g. the previous predefined frequency range of the channel prior to bonding plus the frequency or frequencies that were bonded) is provided e.g. to a CE device for the CE device to be configured to receive content over the bonded channel. Thereafter, at block 104 the logic provides content on the bonded channel.

Turning now to FIG. 5, logic to be executed by a CE device when receiving content over a bonded channel is shown. Beginning at block 110, the logic tunes to a bonded channel e.g. responsive to receiving a notification that content is being provided on the bonded channel and/or an indication of the frequencies included in the bonded channel. The logic then proceeds to block 112 where the logic receives content on the bonded channel, and then at block 114 the logic presents the content.

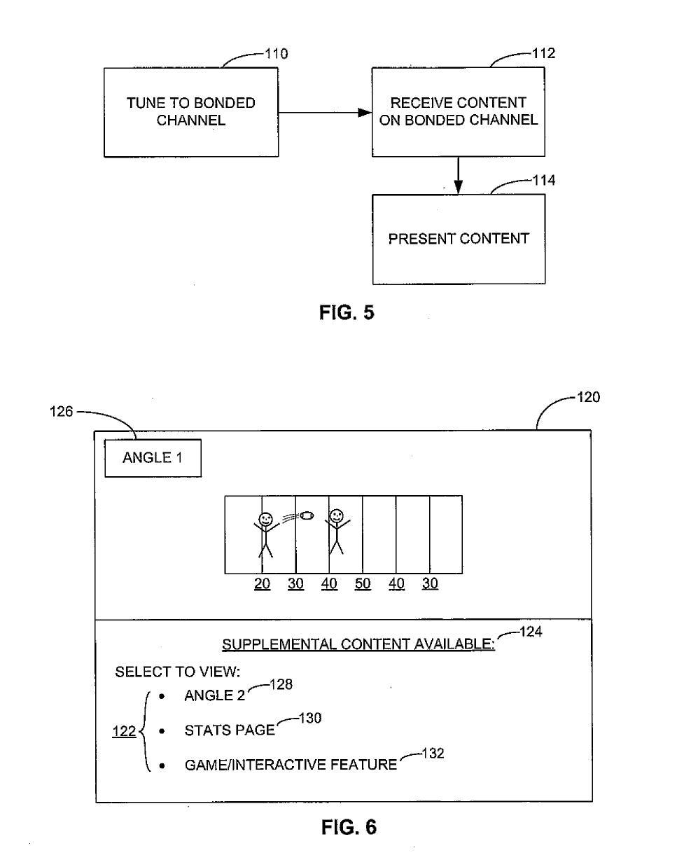

Continuing now in reference to FIGS. 6 and 7, exemplary user interfaces (UIs) that are presentable on a CE device in accordance with present principles are shown. Note that although the UIs of FIGS. 6 and 7 are shown as being overlaid on video of AV content being presented on a display of the CE device, they may in some embodiments be e.g. separately presented on the CE device. Beginning first with FIG. 6, a UI 120 is shown with plural selectable elements 122 (e.g., selectable by manipulating a cursor using a remote control) presented thereon along with an indication 124 (e.g., text) indicating that supplemental content relating to the AV content is available. Also note that the UI 120 may include a portion 126 that may be presented on a different part of the CE device display indicating a current angle of viewing for the content (in the present instance, “Angle One,” and in other instances may indicate e.g. “You are watching Angle One” and/or “You are watching the primary video feed,” etc.). Thus elements 122 include an element 128 selectable to cause the CE device (e.g. automatically without further user input) to present a different camera and/or viewing angle of video for the AV content. For instance, “Angle One” may be a primary viewing angle for a professional football game such as an angle from midfield, whereas “Angle Two” may be an alternate viewing angle from one of the end zones.

In addition to the foregoing, the elements 122 may include an element 130 selectable to cause the CE device (e.g. automatically without further user input) to present metadata associated with the AV content, such as a statistics page of statistics for the football game. The elements 122 may also include an element 132 selectable to cause the CE device (e.g. automatically without further user input) to present an interactive feature associated with the AV content on the CE device, such as e.g. a voting feature for voting on which player should be named the most valuable player of the football game. Before moving on to FIG. 7, it is to be understood that the UI 120 of FIG. 6 may be presented on a CE device when e.g. both the AV content and supplemental content are both provided e.g. either by an MVPD or over a terrestrial broadcast channel.

Continuing in reference to FIG. 7, an exemplary UI 140 is shown that is presentable on a CE device in an embodiment such as e.g. when an MVPD provides AV content but a terrestrial broadcast is to be accessed to access content supplemental to the AV content. The UI 140 may include plural elements 142 presented thereon along with an indication 144 (e.g., text) indicating that supplemental content relating to the AV content is available. It is to be understood that in some embodiments, the elements may be configured to be selectable to cause the CE device to automatically, without further user input, switch sources from e.g. an MVPD source (e.g. providing content through a set top box to the CE device) to a terrestrial broadcast receiver to present the supplemental content, though in some embodiments the elements 142 may instead prompt a user to e.g. change input sources manually by manipulating the CE device. In any case, the elements 142 include an element 146 selectable for presenting a e.g. different viewing angle and/or indicating that a e.g. different viewing angle is available over a specified terrestrial broadcast channel (e.g. even when the AV content of FIG. 7 is being provided through an MVPD). Similarly, an element 148 is shown for presenting metadata associated with the AV content on the CE device, as well as an interactive feature element 150 for presenting an interactive feature on the CE device. Note that the element 150 indicates that the interactive feature may be accessed not over a terrestrial broadcast but instead e.g. by tuning to a different channel provided by an MVPD through a set top box. Thus, present principles recognize that in some embodiments supplemental content to AV content (where, e.g., the AV content is provided by an MVPD) may be accessed both over terrestrial broadcast channels and MVPD-determined channels.

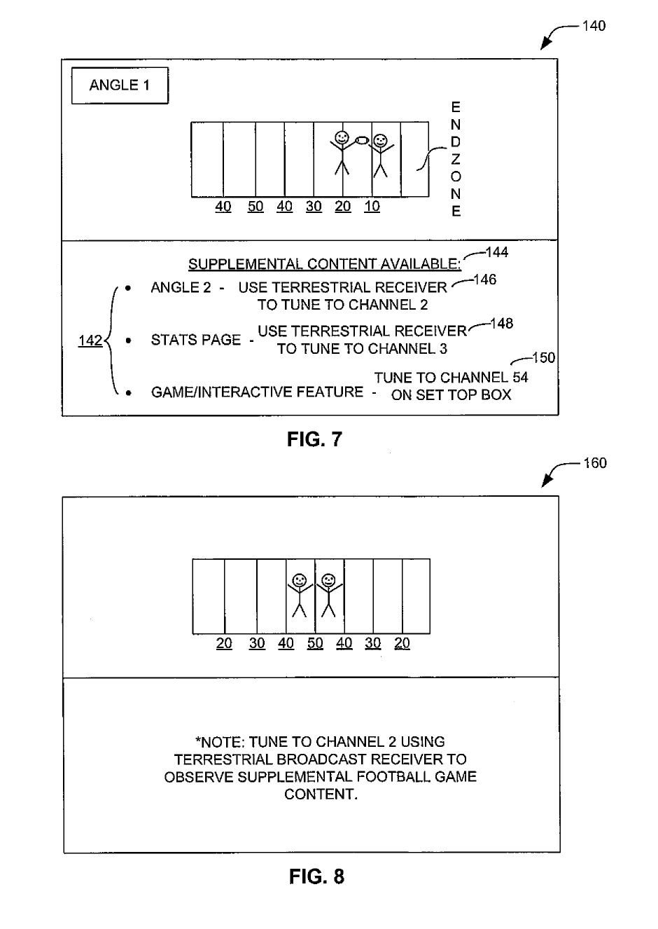

Now in reference to FIG. 8, an example indication and/or notification 160 that may be embedded in video of AV content as set forth herein is shown. The notification 160 (that, e.g. may be blinking, underscored, and/or highlighted) thus indicates that the CE device may be tuned to Channel “X,” a terrestrial broadcast channel, for presentation of supplemental content to AV content provided by an MVPD.

Without reference to any particular figure, it is to be understood that although in some embodiments a database may be accessed indicating available frequencies on which to expand a channel or otherwise transmit data such as supplemental content, in other embodiments no such database is accessed and instead, e.g., the device may expand the channel without accessing such a database (and/or e.g. without sensing bandwidth on an adjacent frequency), or otherwise determine a “hole” in a frequency range without accessing such a database. This may be in embodiments where e.g. channels with predefined frequency ranges (e.g., six MHz) are separated from each other by channel gaps or holes (e.g., “white space”) for otherwise unused frequencies and/or frequencies which do not and indeed are not to form part of a channel (e.g. as determined and/or required by a governmental agency) to e.g. minimize interference between channels. Thus, expanding a channel and/or channel bonding into a “white space frequency” may be undertaken without accessing a database of available frequencies based on determining that no other entity should be using the frequency.

However, in embodiments where a database as referenced herein is accessed, it is to be understood that the database may include e.g. a table of available frequencies that may be changed and/or updated as frequencies become available or unavailable. This may be done at e.g. predefined intervals by mobile DTV devices and/or a controller of the database.

It may now be appreciated that an MVPD and/or broadcaster may accommodate data requests such as requests for AV content and supplemental content even when e.g. a channel on which the AV content is provided (e.g. previously) had a fixed bandwidth and/or capacity that could not accommodate providing all the requested data at one time by e.g. expanding a channel as disclosed herein, bonding a channel as disclosed herein, and/or by finding a “hole” in a frequency spectrum (e.g. an available frequency) even if not next to, close to, adjacent to, etc. the channel on which the primary AV content is provided. Indeed, it is to be understood that an entity controlling one television channel may even sell its excess bandwidth and/or one or more frequencies on which its channel transmits data to another channel or entity associated therewith. Regardless, it is to be understood that bandwidth increases and decreases as contemplated herein are understood to be e.g. dynamic and variable, and hence e.g. after providing increased bandwidth as disclosed herein, it is to be understood that the bandwidth may return to a normal channel size through e.g. resizing or contracting back to the regular channel size when extra bandwidth is no longer needed.

Present principles further recognize that e.g. a spectrum of frequencies may be dynamically rented or otherwise employed e.g. for a predefined period of time such as the length of a sporting event broadcast to thus provide AV content and supplemental content associated therewith when available for a particular broadcast of AV content. This can be done by finding holes in the frequency spectrum for frequencies not currently being used to transmit data as referenced herein, and thus the content provider of the AV content may use bandwidth available in the “hole” for providing at least the supplemental content. In some embodiments mobile DTV databases may be used for determining available frequencies because those databases are updated at least periodically to indicate frequencies being used to transmit data and frequencies that are not being used to transmit data. This “spectrum” for which AV content and supplemental data are to be provided on may be within the ultra high frequency (UHF) band, though it is to be understood that present principles may apply to he very high frequency band (VHF) and still other bands, if desired.

For example, a device (e.g. controlled by a content provider of AV content and associated supplemental content) may access a database for mobile DTVs that indicates spectrum holes (e.g. typically used by white space devices), then sense whether bandwidth is actually (e.g. currently) being used on the frequency indicated in the database as being available (e.g. and/or determining how up to date the mobile DTV database is), and if the frequency is not already being used to transmit data, the device may determine it is free to transmit data thereover and do so accordingly.

In embodiments where an MVPD is transmitting data from a broadcaster to one or more CE devices, the broadcaster once determining an available frequency may inform (e.g. provide an electronic notification) to the MVPD of where to tune (e.g. inform the MVPD of the frequency determined to be available for which the broadcaster will be transmitting data) so that the MVPD may be configured to receive data over that frequency, and then pass the data along to one or more CE devices (e.g. on the same frequency and/or on another frequency as determined by the MVPD). In embodiments where terrestrial broadcast data is being received by a CE device without an MVPD acting as intermediary between the broadcaster and CE device, the broadcaster itself my provide a notification (e.g. directly) to the CE device e.g. via a terrestrial broadcast receiver, mobile DTV receiver, etc. regarding how to access the supplemental content being provided.

Moreover, note that e.g. as soon as the device begins transmitting data over the frequency, the frequency may be “locked in” in the sense that the frequency is no longer available for use by other devices, content providers, etc. for data transmission because the frequency is already in use but may nonetheless at a later time it is to be understood that the frequency may no longer be used (e.g. the channel contracts back to its initial and/or normal frequency range) when a demand for the additional bandwidth ends. Thus, in some embodiments when a content provider determines that bandwidth beyond the fixed bandwidth of the channel on which the content provider transmits data will be required in the future, the provider may determine an available frequency as set forth herein and then begin transmitting data not necessarily having anything to do with the AV content to be provided and/or supplemental content associated therewith (e.g. other AV content), and may even be metadata in that it is meaningless to the CE device and/or is data not meant for presentation on a CE device, thereby “locking in” the channel for when the increased bandwidth will be used by the provider.

Referring again to channel bonding, it is to be understood that when bonding two television channels together (e.g. in the UHF band), e.g. in some embodiments the two channels to be bonded do not share a common and/or overlapping frequency prior to bonding. Even further, in some embodiments when two channels are bonded, the buffer (e.g. white space) that existed therebetween may also form part of the bonded channel and hence provide even more available bandwidth with which to transmit data.

Still without reference to any particular figure, it is to be understood that present principles may be used in embodiments where AV content and supplemental content are received by a CE device only from an MVPD (and hence the MVPD may expand a channel, bond a channel, etc. between the MVPD and the CE device and likewise such a channel may be used between the broadcaster and MVPD as well), over only terrestrial broadcast environments and/or mobile DTV embodiments, and any combination of terrestrial and MVPD environments.

Note that although the term “television channel” has been used herein, present principles are understood to apply to still other forms of AV content-providing channels as well.

Last, note that certain content such as e.g. the supplemental content described herein that is provided by a broadcaster may or may not be authorized for presentation on the CE device depending on the geographic location of the CE device and various content distribution schemes. Thus, a GPS receiver on the CE device may be used for determining the location of the CE device and whether the CE device is authorized to present the AV content and/or supplemental content in accordance with present principles.

While the particular PROVIDING INCREASED BANDWIDTH FOR TRANSMISSION OF AUDIO VIDEO CONTENT AND SUPPLEMENTAL CONTENT ASSOCIATED THEREWITH is herein shown and described in detail, it is to be understood that the subject matter which is encompassed by the present invention is limited only by the claims.

What is claimed is:

1. A first device, comprising:
at least one computer readable storage medium bearing instructions executable by a processor;
at least one processor configured for accessing the computer readable storage medium to execute the instructions to configure the processor for:
providing audio video (AV) content on a first channel, the first channel having a predefined frequency range;
receiving a request for data associated with the AV content;
responsive to receiving the request, determining whether the first channel has sufficient bandwidth to concurrently provide at least portions of both the AV content and the data;
responsive to a determination that the first channel does not have sufficient bandwidth to concurrently provide at least portions of both the AV content and the data, expanding the first channel beyond the predefined frequency range to include at least one frequency above or below the predefined frequency range to render an expanded first channel;
concurrently providing the requested data and AV content over the expanded first channel; and
contracting the first channel back to the predefined frequency range after providing the requested data and AV content.

2. The first device of claim 1, wherein the expanding includes:
accessing a database of available frequencies; and
determining, responsive to parsing at least a portion of the database, at least one available frequency above or below the first channel into which the first channel can expand.

3. The first device of claim 2, wherein the available frequency above or below the first channel is part of a second channel.

4. The first device of claim 3, wherein the available frequency of the second channel into which the first channel is expanded is relinquished to the first channel for a predefined period of time by an entity controlling the second channel.

5. The first device of claim 4, wherein the predefined period is defined by the entity.

6. The first device of claim 2, wherein the available frequency above or below the first channel is part of white space between channels.

7. The first device of claim 2, wherein the expanding includes, responsive to determining at least one available frequency above or below the first channel into which the first channel can expand based on at least a portion of the database, determining whether the at least one available frequency is currently being used for transmitting data.

8. The first device of claim 7, wherein the determining whether the at least one available frequency is currently being used for transmitting data includes sensing whether energy indicative of current content transmission is present at the available frequency.

9. The first device of claim 1, wherein the at least one available frequency above or below the first channel is a frequency used by white space devices.

10. The first device of claim 1, wherein the requested data is first data, and responsive to expanding the first channel to include the at least one frequency above or below the first channel and prior to concurrently providing the requested data and AV content over the expanded first channel, the processor when accessing the instructions is further configured for transmitting second data, the second data not including the first data or the AV content.

11. The first device of claim 10, wherein the second data is dummy data.

12. The first device of claim 1, wherein the request is received from a multichannel video programming distributor (MVPD), wherein the first device is associated with a network broadcaster, and wherein the first device transmits a notification to the MVPD indicating the at least one frequency above or below the predefined frequency range which the MVPD is to tune to receive the requested data.

13. The first device of claim 1, wherein at least a portion of the AV content is provided to a second device through a multichannel video programming distributor (MVPD), and the first device transmits a notification through the MVPD indicating the at least one frequency above or below the predefined frequency range for which the second device is to tune using a terrestrial broadcast receiver at the second device to receive the requested data at the second device.

14. The first device if claim 1, wherein the AV content includes a real time broadcast of an occurrence, and the requested data is video content of a different viewing angle of the occurrence relative to a primary viewing angle.

15. A computer readable storage medium that is not a carrier wave, the computer readable storage medium bearing instructions which when executed by a processor of a first consumer electronics (CE) device configure the processor to execute logic comprising:
receiving content on a first channel, the first channel having a predefined frequency range;
receiving from a provider of the content an indication of a second channel on which supplemental data associated with the content will be provided or is being provided; and
configuring the CE device to receive the supplemental content over the second channel.

16. The computer readable storage medium of claim 15, wherein responsive to receiving the indication and prior to configuring the CE device to receive the supplemental data on the second channel, the processor when executing the instructions is configured for presenting a notification on a display of the CE device that the second channel is providing or will provide the supplemental data.

17. The computer readable storage medium of claim 15, wherein the processor when executing the instructions is configured for receiving the supplemental data over the second channel and presenting the supplemental data on the CE device.

18. A method, comprising:
bonding at least a portion of a first television channel with a second television channel; and
providing content on the bonded channel.

19. The method of claim 18, wherein the first and second television channels each respectively include at least one frequency adjacent to or near a frequency of the other of the first and second television channels.

20. The method of claim 18, wherein the portion is permanently relinquished to the second television channel responsive to the bonding.
